(19) United States
(12) Patent Application Publication
(10) Pub. No.: US 2013/0171286 A1
(43) Pub. Date: Jul. 4, 2013

(54) FEEDING SYSTEM

(71) Applicants: MING-WEI HONG, Tu-Cheng (TW); CHIEN-MING CHANG, Tu-Cheng (TW)

(72) Inventors: MING-WEI HONG, Tu-Cheng (TW); CHIEN-MING CHANG, Tu-Cheng (TW)

(73) Assignee: HON HAI PRECISION INDUSTRY CO., LTD., Tu-Cheng (TW)

(21) Appl. No.: 13/613,278

(22) Filed: Sep. 13, 2012

(30) Foreign Application Priority Data
Dec. 28, 2011 (CN) 201110446536.2

(51) Int. Cl. B29B 13/06

(52) U.S. Cl. 425/162

(57) ABSTRACT

A feeding system includes a hopper, a high-pressure fan, a filter, a controller, and a receiving box. The hopper is filled with plastic material. The controller is connected with the high-pressure fan and the filter. The high-pressure fan, the filter, and the controller are received in the receiving box. The filter is connected to the hopper via a feeding pipe. The high-pressure fan is connected to the feeding pipe. The controller controls the high-pressure fan to generate a pulling force to pull the plastic materials out of the hopper, and controls the filter to filter the plastic material.

### BACKGROUND

1. Technical Field

The present disclosure generally relates to feeding systems, and particularly, to a feeding system integrating a controller, a plurality of high-pressure fans, and a plurality of filters.

2. Description of the Related Art

A product machining process, such as a machining process of an electronic device housing, is generally divided into steps, such as molding and painting. Therefore, the workshops of a factory are designed to be molding workshops and painting workshops. A plurality of molding machines are positioned in the molding workshops, and the molding machines mold a plurality of electronic device housings. Each of the molding machine is equipped with a feeding box for providing plastic materials to the molding machine. In molding, the molding workshop generally needs a plurality of operators to transport the plastic materials to fill the feeding boxes, and thus the labor costs is relatively high. In addition, when relocating the molding workshop, the feeding boxes and the molding machines should be separated from each other, and then should be reassembled in a new molding workshop. Accordingly, it wastes a lot of time to separate and reassemble the feeding boxes and the molding machines.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a feeding system including a container.

FIG. 2 is an isometric view of the inner side of the container of FIG. 1.

### DETAILED DESCRIPTION

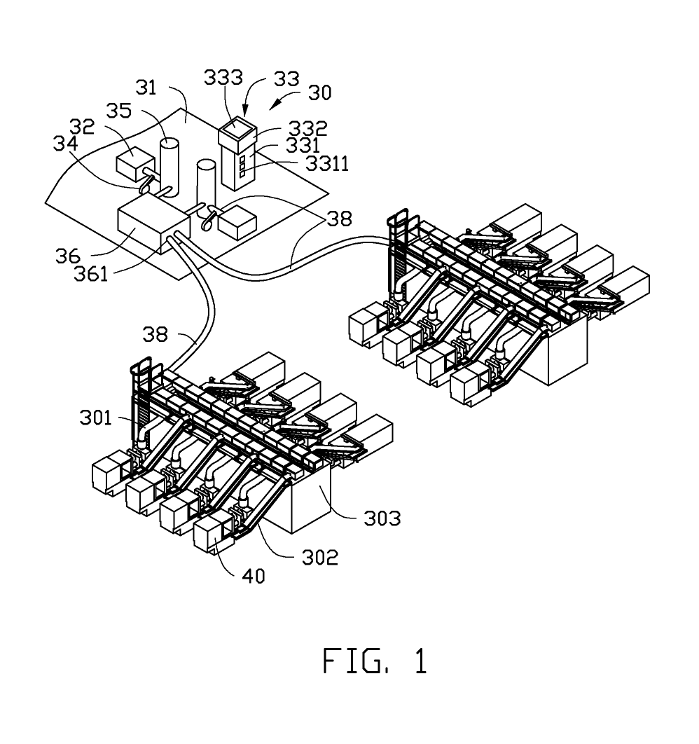

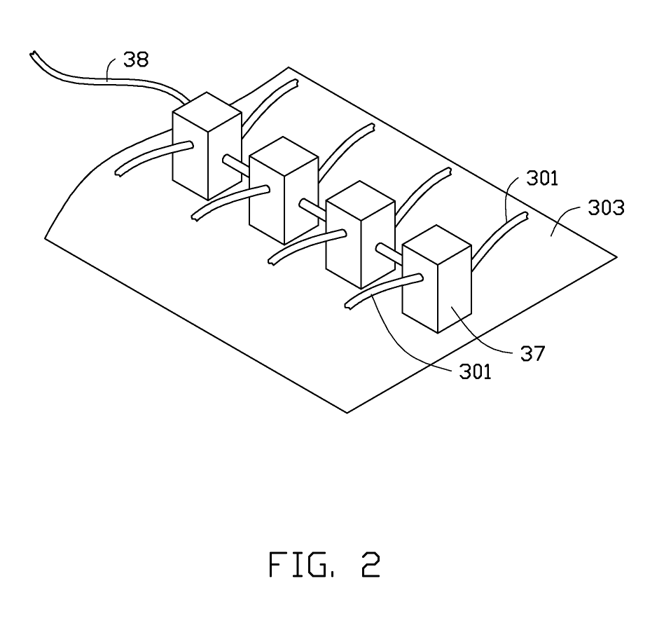

Referring to FIGS. 1 and 2, an embodiment of a feeding system 30 includes a receiving box 31 (FIG. 1 only showing a part of the receiving box 31), two hoppers 32, a controller 33, two high-pressure fans 34, two filters 35, an output box 36, a plurality of dehumidifiers 37, and a plurality of feeding pipes 38 connected therebetween. The feeding boxes 32, the controller 33, the high-pressure fans 34, the filters 35, and the output box 36 are positioned in the receiving box 31. The feeding system 30 is used to provide plastic materials to for a plurality of molding machines 40.

The controller 33 includes a base 331, a control circuit box 332 positioned on the base 331, and a display 333 positioned on the control circuit box 332. In the illustrated embodiment, the display 333 is a touch panel. The base 331 forms a plurality of connecting ports 331 connecting with the high-pressure fans 34 and the filters 35 via electrical wires (not shown), therefore, an operator can control the high-pressure fans 34 and the filters 35 by touching the display 333.

Each feeding box 32 is connected to one corresponding filter 35 via the feeding pipe 38. Each high-pressure fan 34 is connected to the feeding pipe 38 between the feeding box 32 and the filter 35. Each filter 35 is connected to the output box 36 via the feeding pipe 38. In alternative embodiments, the feeding system 30 may includes one or more than two groups consisting of the feeding box 32, the filter 35, and the high-pressure fan 34.

The output box 36 defines one or more feeding port 361, and the dehumidifiers 37 are positioned in one or more containers 303. The dehumidifiers 37 are connected to the feeding port 361 via the feeding pipes 38. In the illustrated embodiment, the output box 36 defines two feeding ports 361, each feeding port 361 is connected to four dehumidifiers 37 via the feeding pipes 38. The dehumidifiers 37 are connected to the molding machines 40 via a plurality of input pipes 301. The four dehumidifiers 37 are positioned in one container 303, thereby facilitating transporting the dehumidifiers 37.

In use, the feeding boxes 32 are filled with plastic materials. The controller 33 starts the high-pressure fans 34 and the filters 35, and a wind speed of the high-pressure fans 34 is set on the display 333. Then, the plastic materials are withdrawn from the feeding boxes 32 under a pulling force generated by the high-pressure fans 34, passes through the filters 35 for filtering dust and fine debris in the plastic material, and enters into the output box 36. The output box 36 transports the plastic material to the dehumidifiers 37, and the dehumidifiers 37 dry plastic. The dehumidifiers 37 transport the plastic material to the molding machines 40 via the input pipes 301. When the molding machines 40 mold the plastic material to a plurality of predetermined products, which can be transported to a next station, such as a painting station, by a product line 302.

Because all of the feeding boxes 32, the controller 33, the high-pressure fans 34, the filters 35, and the output box 36 are positioned in the receiving box 31, and the dehumidifiers 37 are positioned in the container 303, the feeding system 30 is easily relocated by directly transporting the receiving box 31 and the container 303.

In alternative embodiments, the feeding system 30 may also providing products for other machine tools, such as laser marking machines. The feeding boxes 32 can also be positioned outside of the receiving box 31. In addition, the output box 36 and the dehumidifiers 37 may be omitted in the feeding system 30, and the molding machines 40 are directly connected to the filters 35.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A feeding system, comprising:
a feeding box filled with plastic materials;
at least one high-pressure fan;
at least one filter, and
a controller connected with the at least one high-pressure fan and the at least one filter; and
a receiving box, wherein the at least one high-pressure fan, the at least one filter, and the controller are received in the receiving box; the at least one filter is connected to the feeding box via a feeding pipe, the at least one high-pressure fan is connected to the feeding pipe; the controller controls the at least one high-pressure fan to generate a pulling force to pull the plastic materials out of the feeding box, and controls the at least one filter to filter the plastic materials.

2. The feeding system of claim 1, further comprising an output box connected to the at least one filter.

3. The feeding system of claim 2, further comprising a plurality of dehumidifiers connected to the output box, and a plurality of molding machines are connected to the dehumidifiers.

4. The feeding system of claim 3, wherein the dehumidifiers extend a plurality of input pipes connected to a plurality of machine tools.

5. The feeding system of claim 3, wherein the output box is positioned in the receiving box, and the dehumidifiers are positioned outside of the receiving box.

6. The feeding system of claim 5, further comprising a container for receiving the dehumidifiers.

7. The feeding system of claim 3, wherein the machine tools are molding machines.

8. The feeding system of claim 1, wherein the controller comprises a base, a control circuit box positioned on the base, and a display positioned on the control circuit box.

9. The feeding system of claim 8, wherein the base forms a plurality of connecting ports connecting with the high-pressure fans and the filters.

10. The feeding system of claim 8, wherein the display is a touch panel.

11. A feeding system, comprising:
a feeding box;
at least one high-pressure fan;
at least one filter, and
a receiving box, wherein the feeding box, the at least one high-pressure fan, and the at least one filter are received in the receiving box; the at least one filter is connected to the feeding box via a feeding pipe, the at least one high-pressure fan is connected to the feeding pipe.

12. The feeding system of claim 11, further comprising an output box connected to the at least one filter.

13. The feeding system of claim 12, further comprising a plurality of dehumidifiers connected to the output box, and a plurality of molding machines are connected to the dehumidifiers.

14. The feeding system of claim 13, wherein the dehumidifiers extend a plurality of input pipes connected to a plurality of machine tools.

15. The feeding system of claim 13, wherein the output box is positioned in the receiving box, and the dehumidifiers are positioned outside of the receiving box.

16. The feeding system of claim 15, further comprising a container for receiving the dehumidifiers.

17. The feeding system of claim 3, wherein the machine tools are molding machines.
